(19) United States
(12) Patent Application Publication
(10) Pub. No.: US 2026/0186811 A1
(43) Pub. Date: Jul. 2, 2026

(54) PREVENTING MEMORY OVERRIDES AND LATENCY DURING A POST-COPY MIGRATION OF A VIRTUAL MACHINE

(71) Applicant: RED HAT, INC., Raleigh, NC (US)

(72) Inventors: Michael Tsirkin, Yokneam (IL); Eugenio Antolin Pérez Martín, Sevilla (ES)

(21) Appl. No.: 19/002,011

(22) Filed: Dec. 26, 2024

(51) Int. Cl. G06F 9/455

(52) U.S. Cl. CPC G06F 9/45558; G06F 2009/4557; G06F 2009/45575; G06F 2009/45595

(57) ABSTRACT

During a post-copy migration process, latency and memory overrides can be avoided by implementing some techniques described herein. For example, during a post-copy migration process involving migrating a virtual machine from a source computing device to the destination computing device, a hypervisor can start the virtual machine on the destination computing device. After starting the virtual machine, the hypervisor can receive a message associated with storing data from a passthrough device to a virtual memory segment of the virtual machine on the destination computing device. Based on receiving the message, the hypervisor can prevent the virtual memory segment from being migrated from the source computing device to the destination computing device. This can prevent the data from the passthrough device from being overridden.

### TECHNICAL FIELD

The present disclosure relates generally to migrating a virtual machine from a source computing device to a destination computing device. More specifically, but not by way of limitation, this disclosure relates to preventing memory overrides and latency during a post-copy migration of a virtual machine.

### BACKGROUND

A virtual machine is a software emulation of a physical computer that can have its own operating system, software applications, and virtualized hardware. For example, a virtual machine can have a virtual Central Processing Unit (vCPU), a virtual Random Access Memory (vRAM), virtual drivers, and other virtualized components. Virtual machines provide isolation that can enhance security, resource utilization, and flexibility.

Virtual machines can be deployed on a physical machine using a hypervisor. A hypervisor is a software layer that is conceptually positioned above a physical layer (e.g., the hardware) of the physical machine and below the virtual machine, such that the hypervisor serves as an interface between the physical layer and the virtual machine. A hypervisor can allow multiple virtual machines to run concurrently on a single physical machine by abstracting and managing the underlying hardware resources of the physical machine.

After a virtual machine has been deployed on a physical machine, in some cases it may be desirable to migrate the virtual machine to another physical machine. One way of performing such a migration is referred to as post-copy migration. Post-copy migration is a technique for moving a virtual machine from a source computing device to a destination computing device, while keeping the virtual machine live. During a post-copy migration, the transfer of the virtual machine’s memory is at least partially deferred until after its processor state has been sent to the destination computing device. This deferral contrasts with the traditional pre-copy approach, in which the memory state is first copied to the destination computing device, followed by a final transfer of the processor state. Post-copy migration generally involves the following steps: suspending the virtual machine on the source computing device, transferring a minimum subset of the virtual machine’s execution state (e.g., CPU state, registers, and optionally non-pageable memory) to the destination computing device, resuming the virtual machine on the destination computing device, and then transferring the remaining memory pages of the virtual machine from the source computing device to the destination computing device over time.

### BRIEF DESCRIPTION OF THE DRAWINGS

FIG. 1 shows a block diagram of an example of a system for preventing memory overrides and latency during a post-copy migration of a virtual machine according to some aspects of the present disclosure.

FIG. 2 shows a block diagram of an example of a system for preventing memory overrides and latency during a post-copy migration of a virtual machine according to some aspects of the present disclosure.

FIG. 3 shows a flowchart of an example of a process for preventing memory overrides and latency during a post-copy migration of a virtual machine according to some aspects of the present disclosure.

### DETAILED DESCRIPTION

Post-copy migration is one way of migrating a virtual machine from a source computing device to a destination computing device. However, post-copy migration has some drawbacks, like the introduction of latency in the execution of the virtual machine. For example, while a post-copy migration is ongoing, the virtual machine running on the destination computing device may request data stored in a memory page. If the memory page has not yet been received from the source computing device, a page fault can be triggered. Based on the page fault, the destination computing device can fetch the required memory page from the source computing device. This can involve the destination computing device transmitting a request for the memory page over a network to the source computing device, which can then transmit the requested memory page over the network to the destination computing device. But this roundtrip process introduces latency, since the virtual machine will pause at least some of its operations until the requested data is received, which depends on how long these network communications take to complete. Such network communications also consume valuable network bandwidth.

In addition to latency, post-copy migration can also raise other problems. For example, post-copy migration is typically incompatible with the use of passthrough devices. A passthrough device may be a physical device or a virtualized device that is assigned to a virtual machine, so that the virtual machine can access it directly (bypassing the hypervisor). During the post-copy migration process, if a passthrough device is assigned to the virtual machine, the passthrough device may write data to a virtual memory page of the virtual machine. But such data may unintentionally be overridden when the same memory page is eventually migrated from the source computing device to the destination computing device. For example, if the passthrough device writes data to a certain memory page at a certain memory address, the data may then be overridden when the same memory page at the same address is subsequently transferred from the source computing device to the destination computing device as part of the post-copy migration process. Because this loss of data can raise numerous problems, most systems avoid this risk by prohibiting the use of passthrough devices altogether with a virtual machine until after the migration is complete. But prohibiting the use of passthrough devices until after the migration is complete can significantly limit the functional capabilities of the virtual machine during the post-copy migration process.

Some examples of the present disclosure can overcome one or more of the abovementioned problems by, during a post-copy migration process of a virtual machine from a source computing device to a destination computing device, detecting that a passthrough device has stored or will store data in a memory segment (e.g., buffer, page, or chunk) of the virtual machine on the destination device. In response to this detection, the destination computing device can prevent the corresponding memory segment from being migrated from the source computing device to the destination computing device during the post-copy migration process. This can prevent the stored data from being unintentionally overridden with the corresponding memory segment from the source computing device, which may now be stale. This can also avoid the latency that would normally arise from fetching the memory segment from the source computing device.

As one particular example, during a post-copy migration process for a virtual machine, a passthrough device can be assigned to the virtual machine on the destination computing device. In this example, the passthrough device can be a network interface card (NIC), such as a physical network interface card (pNIC) or a virtualized network interface card (vNIC). During the post-copy migration process, the NIC can receive data packets over a network connection and store the data packets in a buffer. The buffer can be stored in a virtual memory segment of the virtual machine. Normally, at least some of the buffer may be overridden when a corresponding virtual memory segment is transferred from the source computing device to the destination computing device. Hence, this type of passthrough configuration may not even be allowed in a typical computing system, to avoid the risk of the buffer being overridden and the data packets being lost. But in some examples, a hypervisor executing on the destination computing device can detect that the data packets have been stored in the buffer, determine the memory segment that contains the buffer, and prevent the corresponding memory segment from being migrated from the source computing device to the destination computing device. For example, the hypervisor may simply not fetch the memory segment from the source computing device. As another example, the hypervisor may transmit a communication to the source computing device to notify the source computing device not to transmit the memory segment. Either way, by preventing the memory segment from being transferred, the buffer’s contents can be retained rather than overridden. Additionally, the normal latency and bandwidth consumption associated with such a network transfer can be avoided.

These illustrative examples are given to introduce the reader to the general subject matter discussed here and are not intended to limit the scope of the disclosed concepts. The following sections describe various additional features and examples with reference to the drawings in which like numerals indicate like elements but, like the illustrative examples, should not be used to limit the present disclosure.

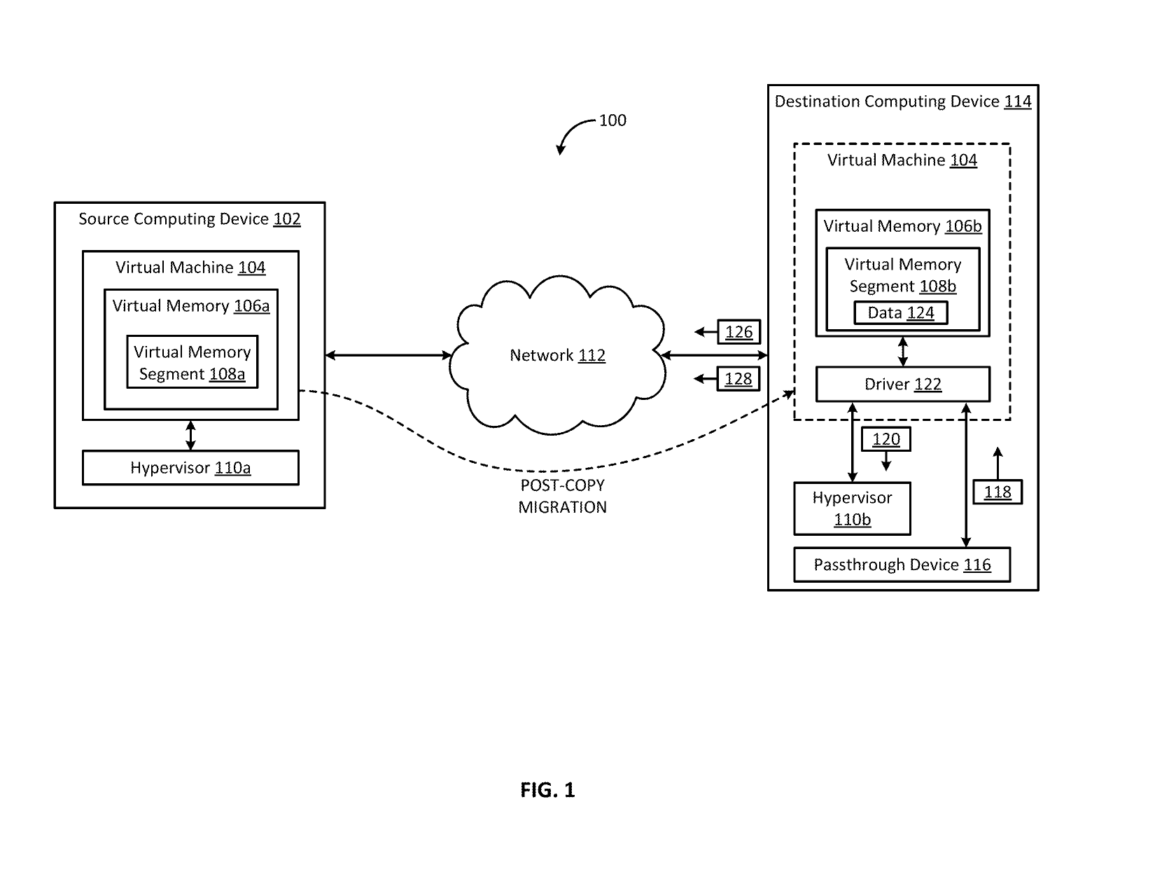

FIG. 1 shows a block diagram of an example of a system 100 for preventing latency and memory overrides during a post-copy migration of a virtual machine 104 according to some aspects of the present disclosure. The system 100 includes a source computing device 102, which contains the virtual machine 104 prior to the migration. The source computing device 102 can include a hypervisor 110a that manages the execution of the virtual machine 104 on the source computing device 102. During the post-copy migration process, the hypervisor 110a can assist in transferring the processor state data and virtual memory of the virtual machine 104 to the destination computing device 114.

The system 100 also includes a destination computing device 114, which contains the virtual machine 104 after the migration. The destination computing device 114 can also include a hypervisor 110b that manages the execution of the virtual machine 104 on the destination computing device 114. During the post-copy migration process, the hypervisor 110b can assist in the transfer of the processor state data and virtual memory from the source computing device 102 (e.g., from the hypervisor 110a).

The source computing device 102 and the destination computing device 114 can communicate with one another via one or more networks 112. The one or more networks 112 may include a private network such as a local area network, a public network such as the Internet, or a combination thereof. In some examples, the source computing device 102 and the destination computing device 114 may be part of the same computing environment. For instance, the source computing device 102 and the destination computing device 114 may be different nodes of the same cloud computing environment. In other examples, the source computing device 102 and the destination computing device 114 may be located in different computing environments. For instance, the source computing device 102 may be located in an on-premises computing environment and the destination computing device 114 may be located in a cloud computing environment.

During the post-copy migration, a passthrough device 116 can be assigned to the virtual machine 104. The passthrough device 116 may be a physical hardware device (e.g., that is coupled to the destination computing device 114) or a virtualized passthrough device. Examples of passthrough devices can include Peripheral Components Interconnect (PCI) cards, such as a network interface card or a graphics processing unit (GPU). The virtual machine 104 can include a virtual driver 122 for use in interacting with the passthrough device 116. For example, if the passthrough device 116 is a network interface card, the virtual machine 104 can include a guest driver configured to interface with the network interface card.

At some point in time during the post-copy migration, while the virtual machine 104 is executing on the destination computing device 114, the passthrough device 116 can transmit a request 118 to write data 124 to a virtual memory segment 108b in a virtual memory 106b of the virtual machine 104. In some examples, the virtual memory segment 108b may be a memory page that extends between two memory addresses. The request 118 can identify the virtual memory segment 108b to which to write the data 124, for example by the segment’s memory address and/or offset. The request 118 may be received by the virtual driver 122. The virtual driver 122 can respond to the request 118 by notifying the hypervisor 110b about the write. For example, the virtual driver 122 can transmit a message 120 to the hypervisor 110b, where the message 120 is indicative of the data write to the virtual memory segment 108b. The message 120 can identify the virtual memory segment 108b, for example by its memory address and/or offset. In some examples, if the virtual memory segment 108b has not already been allocated to the virtual machine 104, the hypervisor 110b can allocate the virtual memory segment 108b to the virtual machine 104 for use in storing the data 124.

In some examples, the hypervisor 110b may generate the message 120. For example, if the passthrough device 116 is a virtualized (e.g., emulated) passthrough device, it may be managed by the hypervisor 110b. In that situation, the message 120 may both be generated and received by the hypervisor 110b based on the virtual operation of the virtualized passthrough device.

In response to receiving the message 120, the hypervisor 110b can prevent the corresponding memory segment 108a from being migrated from the source computing device 102 to the destination computing device 114. For example, the hypervisor 110b can block the transfer of the memory segment 108a from the source computing device 102. Alternatively, the hypervisor 110b can discard the memory segment 108a if it has already been received, so that the data 124 is not overridden. As another example, the hypervisor 110b may be responsible for fetching memory segments from the source computing device 102 during the migration process. In that scenario, the hypervisor 110b can forego fetching the memory segment 108a from the source computing device 102. As still another example, the hypervisor 110b can transmit a communication 126 to the source computing device 102 notifying the source computing device 102 not to transmit the memory segment 108a. In response to receiving the communication 126, the source computing device 102 may forego transmitting the memory segment 108a to the destination computing device 114. In addition to preventing the migration of the virtual memory segment 108a, in some examples the hypervisor 110b can transmit a communication 128 to the source computing device 102, where the communication 128 is configured to cause the source computing device 102 to discard the virtual memory segment 108a, since it is no longer needed. Discarding the virtual memory segment 108a may involve deleting the contents of the virtual memory segment 108a from memory. It will be appreciated that although the communications 126, 128 are shown and described as being distinct from one another, in some examples they may be the same communication.

The above process can repeat over time during the post-copy migration, for example as one or more passthrough devices store data to virtual memory segments of the virtual memory 106b associated with the virtual machine 104. By implementing this process, the hypervisor 110b can prevent the stored data from being overridden with content subsequently migrated from the source computing device 102.

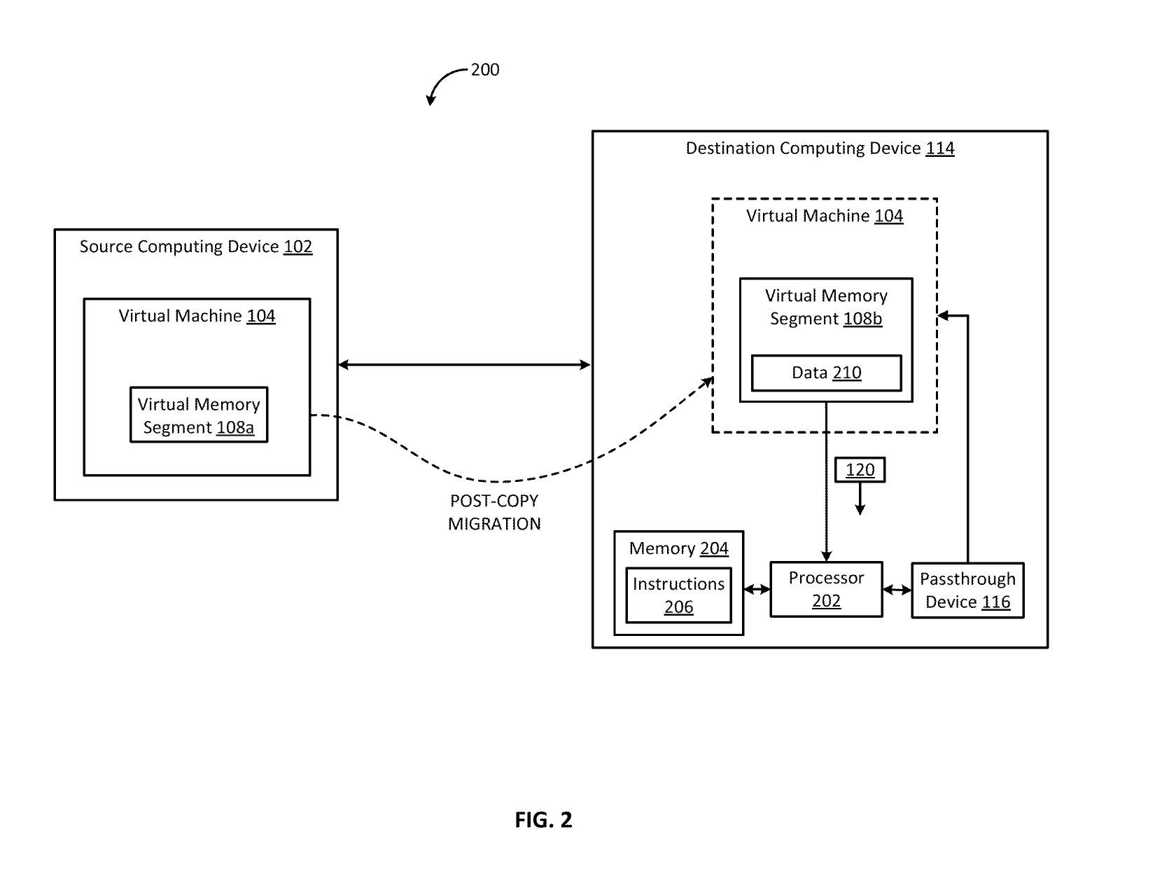

Turning now to FIG. 2, shown is a block diagram of an example of a system 200 for preventing memory overrides and latency during a post-copy migration of a virtual machine 104 according to some aspects of the present disclosure. The system 200 includes a processor 202 communicatively coupled to a memory 204 by a bus. The processor 202 can include one processing device or multiple processing devices. Non-limiting examples of the processor 202 include a Field-Programmable Gate Array (FPGA), an application-specific integrated circuit (ASIC), a microprocessor, or any combination of these. The processor 202 can execute instructions 206 stored in the memory 204 to perform operations, such as any of the operations described above with respect to the hypervisor 110b. In some examples, the instructions 206 can include processor-specific instructions generated by a compiler or an interpreter from code written in any suitable computer-programming language, such as C, C++, C#, Python, or Java.

The memory 204 can include one memory device or multiple memory devices. The memory 204 can be volatile or non-volatile, such that the memory 204 retains stored information when powered off. Non-limiting examples of the memory 204 include electrically erasable and programmable read-only memory (EEPROM), flash memory, or any other type of non-volatile memory. At least some of the memory device can include a non-transitory computer-readable medium from which the processor 202 can read the instructions 206. A computer-readable medium can include electronic, optical, magnetic, or other storage devices capable of providing the processor 202 with computer-readable instructions or other program code. Non-limiting examples of a computer-readable medium can include magnetic disks, memory chips, ROM, random-access memory (RAM), an ASIC, a configured processor, optical storage, or any other medium from which a computer processor can read the instructions 206.

The processor 202 can execute the instructions 206 to perform operations during a post-copy migration process, which involves migrating a virtual machine 104 from a source computing device 102 to a destination computing device 114. For example, the processor 202 can start the virtual machine 104 on the destination computing device 114. After starting the virtual machine 104, the processor 202 can receive a message 120 associated with storing data 210 to a virtual memory segment 108b of the virtual machine 104 on the destination computing device 114. For example, the message 120 can indicate that the data 210 has been stored or will be stored in the virtual memory segment 108b. The data 210 can be from a passthrough device 116 which, in turn, may have generated the data 210 or received the data 210 from another source. Based on receiving the message 120, the processor 202 can prevent the virtual memory segment 108a (e.g., the corresponding segment of memory) from being migrated from the source computing device 102 to the destination computing device 114. Some or all of the above operations may be performed by a hypervisor executing on the destination computing device 114.

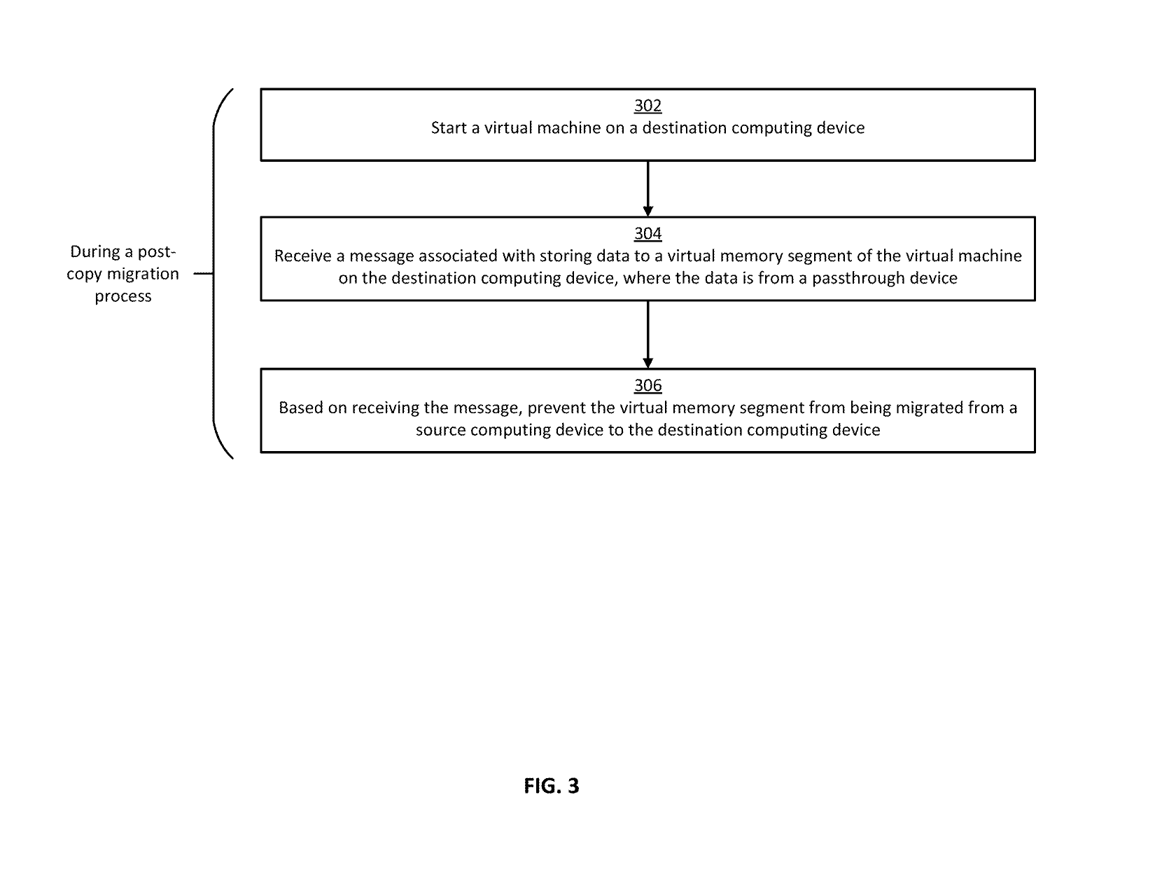

Turning now to FIG. 3, shown is a flowchart of an example of a process for preventing memory overrides and latency during a post-copy migration of a virtual machine according to some aspects of the present disclosure. Other examples may include more operations, fewer operations, different operations, or a different sequence of operations than is shown. The operations of FIG. 3 are described below with reference to the components of FIGS. 1-2 described above.

Some or all of the following operations can take place during a migration process, in which a virtual machine 104 is migrated from a source computing device 102 to the destination computing device 114. And, some or all of the following operations may be performed by a hypervisor executing on the processor 202 of the destination computing device 114.

In block 302, the processor 202 starts the virtual machine 104 on the destination computing device 114. When starting the virtual machine 104, the processor 202 may use processor state data from the source computing device 102. The processor state data can correspond to the current processor state of the virtual machine 104 on the source computing device 102, as of or around the time that the migration began. By using the processor state data, the processor 202 may start the virtual machine 104 on the destination computing device 114 with the same or a similar processor state as it had on the source computing device 102 when the migration began.

When the virtual machine 104 is started, at least some of the contents of the virtual machine’s virtual memory have not been migrated yet from the source computing device 102 to the destination computing device 114. Thus, there may still be at least some of the contents of the virtual memory remaining on the source computing device 102 awaiting transfer to the destination computing device 114.

In block 304, after starting the virtual machine 104, the processor 202 receives a message 120 associated with storing data 210 to a virtual memory segment 108b of the virtual machine 104 on the destination computing device 114. The data 210 can be provided by a passthrough device 116, which can generate or otherwise obtain the data 210. In some examples, the virtual memory segment 108b can include a buffer for storing the data 210.

In some examples, the message 120 may have been sent from the virtual machine 104. For instance, a virtual driver 122 of the virtual machine 104 can transmit the message 120. In some examples, the virtual machine 104 may transmit the message 120 based on the passthrough device 116 writing, or requesting to write, the data 210 to the virtual memory segment 108b of the virtual machine 104.

In block 306, based on receiving the message 120, the processor 202 prevents the virtual memory segment 108a from being migrated from the source computing device 102 to the destination computing device 114. In some examples, the processor 202 can block the transfer of the memory segment 108a from the source computing device 102. For instance, the processor 202 can block data packets associated with the memory segment 108a from the source computing device 102. As another example, if the memory segment 108a has already been received at the destination computing device 114, the processor 202 can discard the memory segment 108a, rather than using it to override the data 210, thus preventing the migration of the memory segment 108a from being completed. As still another example, the processor 202 can transmit a communication 126 to the source computing device 102 notifying the source computing device 102 not to transmit the memory segment 108a. In response to receiving the communication 126, the source computing device 102 may forego transmitting the memory segment 108a to the destination computing device 114.

As yet another example, in some cases, the processor 202 (e.g., the hypervisor executing thereon) may be responsible for directing the transfer of memory segments from the source computing device 102 during the migration process. For instance, during the migration process, memory segments may only be transferred from the source computing device 102 to the destination computing device 114 when they are specifically fetched (e.g., requested) by the processor 202. In some implementations, the processor 202 may only fetch memory segments after they have been requested by the virtual machine 104. For instance, the virtual machine 104 may request data from a particular memory segment. If that particular memory segment has not already been migrated, it may trigger a page fault. The processor 202 can detect the page fault and responsively fetch the required memory segment from the source computing device 102. By waiting to fetch memory segments until after they have been requested by the virtual machine 104, bandwidth consumption can be reduced and distributed over time. For instance, some memory segments may never be fetched if they are never requested from the virtual machine 104, thus reducing bandwidth consumption as compared to other migration approaches in which all of the memory segments are transmitted regardless. Within this context, if the processor 202 receives the message 120, the processor 202 may forego fetching the memory segment 108a from the source computing device 102. This can prevent the memory segment 108a from being migrated from the source computing device 102 to the destination computing device 114.

Regardless of how the processor 202 prevents the migration of the memory segment 108a, in some examples, the processor 202 may also transmit a communication 128 to the source computing device 102, where the communication 128 is configured to cause the source computing device 102 to discard the virtual memory segment 108a. The virtual memory segment 108a can be discarded because it is no longer needed. In response to receiving the communication 128, the source computing device 20 can discard the virtual memory segment 108a – e.g., by deleting the contents of the virtual memory segment 108a from its local memory.

In some examples, based on receiving the message 120, the processor 202 prevents the virtual memory segment 108b from being overridden on the destination computing device 114. This may be achieved using any of the techniques described above. For example, the processor 202 can prevent the virtual memory segment 108b from being overridden by blocking the transfer of the memory segment 108a from the source computing device 102. As another example, if the memory segment 108a has already been received at the destination computing device 114, the processor 202 can discard the memory segment 108a, rather than using it to override the data 210, thus preventing the virtual memory segment 108b from being overridden. As still another example, the processor 202 can transmit a communication 126 to the source computing device 102 notifying the source computing device 102 not to transmit the memory segment 108a. In response to receiving the communication 126, the source computing device 102 may forego transmitting the memory segment 108a to the destination computing device 114, which can prevent the virtual memory segment 108b from being overridden.

The foregoing description of certain examples, including illustrated examples, has been presented only for the purpose of illustration and description and is not intended to be exhaustive or to limit the disclosure to the precise forms disclosed. Numerous modifications, adaptations, and uses thereof will be apparent to those skilled in the art without departing from the scope of the disclosure. For instance, any examples described herein can be combined with any other examples to yield further examples.

1. A non-transitory computer-readable medium comprising program code for a hypervisor of a destination computing device, the hypervisor being executable to perform operations including:
during a post-copy migration process involving migrating a virtual machine from a source computing device to the destination computing device:
starting the virtual machine on the destination computing device;
after starting the virtual machine, receiving a message associated with storing data to a virtual memory segment of the virtual machine on the destination computing device, wherein the data is from a passthrough device; and
based on receiving the message, preventing the virtual memory segment from being migrated from the source computing device to the destination computing device.

2. The non-transitory computer-readable medium of claim 1, wherein the data includes a data packet received by the passthrough device, the passthrough device including a network interface card (NIC).

3. The non-transitory computer-readable medium of claim 1, wherein the operations further comprise, in response to receiving the message:
allocating, by the hypervisor, the virtual memory segment on the destination device for use in storing the data from the passthrough device; and
storing, by the hypervisor, the data in the virtual memory segment.

4. The non-transitory computer-readable medium of claim 1, wherein the operations further comprise:
based on receiving the message, transmitting a communication to the source computing device, the communication being configured to cause the source computing device to delete the virtual memory segment from a local memory of the source computing device.

5. The non-transitory computer-readable medium of claim 1, wherein the virtual memory segment is a memory page that extends between two memory addresses.

6. The non-transitory computer-readable medium of claim 1, wherein the virtual memory segment includes a buffer configured to store the data.

7. The non-transitory computer-readable medium of claim 1, wherein the message is received by the hypervisor from the virtual machine.

8. A method implemented by a hypervisor of a destination computing device, the method comprising:
during a post-copy migration process involving migrating a virtual machine from a source computing device to the destination computing device:
starting the virtual machine on the destination computing device;
after starting the virtual machine, receiving a message associated with storing data to a virtual memory segment of the virtual machine on the destination computing device, wherein the data is from a passthrough device; and
based on receiving the message, preventing the virtual memory segment from being migrated from the source computing device to the destination computing device.

9. The method of claim 8, wherein the data includes a data packet received by the passthrough device, the passthrough device including a network interface card (NIC).

10. The method of claim 8, further comprising, in response to receiving the message:
allocating the virtual memory segment on the destination device for use in storing the data from the passthrough device; and
storing the data in the virtual memory segment.

11. The method of claim 8, further comprising:
based on receiving the message, transmitting a communication to the source computing device, the communication being configured to cause the source computing device to delete the virtual memory segment from a local memory of the source computing device.

12. The method of claim 8, wherein preventing the virtual memory segment from being migrated from the source computing device to the destination computing device involves:
transmitting a communication to the source computing device, the communication being configured to cause the source computing device to forego transmitting the virtual memory segment during the post-copy migration process.

13. The method of claim 8, wherein preventing the virtual memory segment from being migrated from the source computing device to the destination computing device involves:
foregoing fetching the virtual memory segment from the source computing device during the post-copy migration process.

14. The method of claim 8, wherein the message is received by the hypervisor from a driver of the virtual machine.

15. A destination computing device comprising:
a processor; and
a memory storing instructions that are executable by the processor for causing the processor to perform operations including:
during a post-copy migration process involving migrating a virtual machine from a source computing device to the destination computing device:
starting the virtual machine on the destination computing device;
after starting the virtual machine, receiving a message associated with storing data to a virtual memory segment of the virtual machine on the destination computing device, wherein the data is from a passthrough device; and
based on receiving the message, preventing the virtual memory segment from being migrated from the source computing device to the destination computing device.

16. The destination computing device of claim 15, wherein the data includes a data packet received by the passthrough device, the passthrough device including a network interface card (NIC).

17. The destination computing device of claim 15, wherein the operations further comprise, in response to receiving the message:
allocating the virtual memory segment on the destination device for use in storing the data from the passthrough device; and
storing the data in the virtual memory segment.

18. The destination computing device of claim 15, wherein the operations further comprise:
based on receiving the message, transmitting a communication to the source computing device, the communication being configured to cause the source computing device to delete the virtual memory segment from a local memory of the source computing device.

19. The destination computing device of claim 15, wherein preventing the virtual memory segment from being migrated from the source computing device to the destination computing device involves:
foregoing fetching the virtual memory segment from the source computing device during the post-copy migration process.

20. The destination computing device of claim 15, wherein the message is received from a driver of the virtual machine.
